(19) United States
(12) Patent Application Publication
(10) Pub. No.: US 2026/0187646 A1
(43) Pub. Date: Jul. 2, 2026

(54) SYSTEMS AND METHODS FOR AUTOMATIC PROMPT GENERATOR FOR GENERATIVE AI MODEL

(71) Applicant: American Express Travel Related Services Company, Inc., New York, NY (US)

(72) Inventors: Sibish BASHEER, Phoenix, AZ (US); Matthew B. PETERS, Peoria, AZ (US)

(73) Assignee: American Express Travel Related Services Company, Inc., New York, NY (US)

(21) Appl. No.: 19/007,038

(22) Filed: Dec. 31, 2024

(51) Int. Cl. G06Q 30/015; H04L 51/046

(52) U.S. Cl. CPC G06Q 30/015; H04L 51/046

(57) ABSTRACT

Disclosed herein are system, method, and computer program product embodiments for a combination of an automatic model prompt generator and generative model that work together to generate prompt customized prompt inputs for the generative model in the context of real-time communication between a user device and service device. During a real-time communication session between an agent terminal and a customer device, the prompt generator and generative model are configured to work together to generate visual elements for facilitating communications during the session. The system may further be configured to detect triggers within the real-time communication to automatically initiate the prompt generator and generative model. Output of the generative model, which are customized based on the context and information of the communication session, may be provided as visual elements during the real-time communication.

### FIELD OF INVENTION

One or more implementations relate to the field of machine learning models, and more specifically to a combination of an automatic prompt generator and generative model that work together to generate customized prompt inputs for the generative model in the context of real-time communication between a user device and service device.

### BACKGROUND

In the field of machine learning models, it is known that the quality of outputs depends on the quality of the inputs. Providing these inputs, or prompts, is typically a trial-and-error process, where prompts are refined iteratively based on the output generated by a prior prompt. The technological problem arises when machine learning models are deployed in real-time environments. These real-time environments typically can include real-time interactions and therefore the iterative process for generating outputs results in the model not being able to be utilized within such interactions. Moreover, the real-time environment may involve technical expertise and providing an appropriate prompt in such environments can be rather technical in nature, and may require specific phrasing and/or directives that might be outside of natural language. Conventional implementations of machine learning models therefore have technical limitations within such environments.

### BRIEF DESCRIPTION OF THE DRAWINGS

The accompanying drawings are incorporated herein and form a part of the specification.

FIG. 1 illustrates an exemplary customer service environment, according to aspects of the present disclosure.

FIG. 2 illustrates an exemplary agent terminal for use in the customer service environment according to aspects of the present disclosure.

FIG. 3 illustrates an exemplary agent assistance system for use by the agent terminal according to aspects of the disclosure.

FIG. 4 illustrates an exemplary method for initiating an AI assistance request according to aspects of the present disclosure.

FIG. 5 illustrates a flowchart diagram of an exemplary method for providing AI assistance to an agent.

FIG. 6 illustrates a block diagram of an exemplary computer system for implementing one or more aspects of the disclosed embodiments according to various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for an improved machine learning prompt based system that includes first machine learning model that operates as an AI prompt producer for automatically generating AI prompts to be used as input for a generative AI model in communication with the first machine learning model.

In real-time communication sessions, such as customer service agent environments between a user device and an agent device, agent devices often transmit live communications to user devices, and agents associated with the agent devices typically attempt to resolve the user problems in real-time. This can lead to a number of different problems that may result in a negative customer experience. For example, in order to present an appearance of low wait time, the agent may follow a rigid set of responses that are not narrowly tailored to the specific circumstances of the customer. Alternatively, an agent may not be aware of the specific solution needed, and may propose incorrect solutions, or may expend significant time researching in order to find the appropriate response.

Many different factors may affect the agent's ability to correctly respond to the customer, including the agent's experience, the agent's expertise in the specific area of the customer's problem, past interactions that the agent has had with other same or similar problems, the number of customers currently being serviced by the agent, etc. As such, there is a need to quickly and efficiently identify and locate an appropriate action to be taken in response to a customer problem that minimizes agent error and accounts for these agent variables.

Using a machine learning model by itself as part of this real-time networking environment is not sufficient to address these challenges because providing inputs to the model to arrive at a desired output is typically an iterative process of refining the input until the desired output is provided by the model.

In order to address the technical challenge of deploying a machine learning model within real-time networking environments, the present disclosure provides a technical solution to these challenges by leveraging a sequence of models in combination. First, a prompt model trained as an intelligent agent prompt producer that is uniquely tuned to operate in a real-time communication session and based on characteristics associated with the user, agents, and agent devices, and, in some embodiments, based on contextual data of communications with the real-time communication session. The prompt producer can be configured to monitor real-time communications between a user device and a service device. During the real-time communication session, the prompt producer is in communication with (e.g., by providing dynamic prompts) a generative AI model, which is configured to generate output for updating a user interface on the agent device. The prompt producer can generate dynamic prompts based on any combination of characteristics associated with the user device, characteristics associated with the agent devices, and a detected subject matter of the real-time communication session, as well as others that will be described herein. Connecting the output of the prompt producer (e.g., dynamic prompts) as inputs for the generative AI model allows the generative AI model to produce customized user interfaces in the context of a real-time communication that include targeted responses to address detected subject matter (e.g., customer issues) that can readily be carried out by an agent of any skill or expertise, and that is likely to address the customer's problem with reduced error. As a result, through the unique configuration of the prompt producer and the generative AI model within a real-time communication session, wait times and customer sentiment are both improved. In some embodiments, the prompt producer and the generative AI model are configured to operate in sequence based on inputs to the prompt producer to dynamically generate outputs from the generative AI model. These and other aspects will be described below with respect to the various figures.

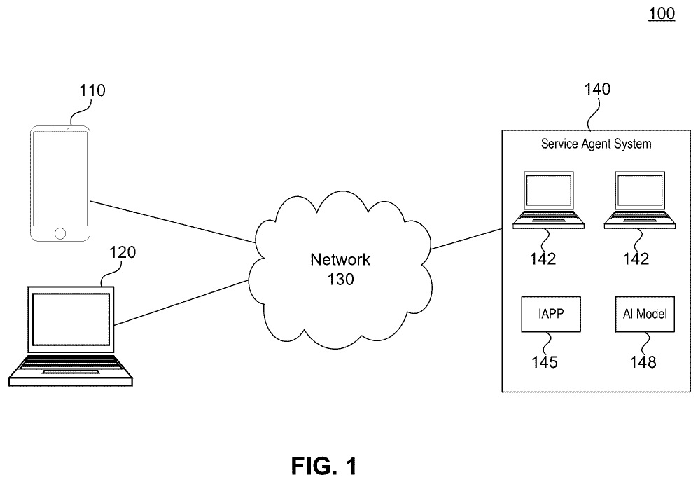

FIG. 1 illustrates an exemplary customer service environment 100, according to aspects of the present disclosure. As shown in FIG. 1, the customer service environment 100 includes a user devices 110 and 120 in the form of a mobile device or personal computer. In various embodiments, user device 110 may comprise a smartphone, tablet computer, personal digital assistant smartwatch, or any other Internet-ready portable device capable of communicating over a network.

The user devices 110 and 120 communicate with a service agent system 140 over network 130. In various embodiments, the network 130 may be any type of computer or telecommunications network capable of communicating data, for example, a local area network, a wide-area network (e.g., the Internet), or any combination thereof. The network may include wired and/or wireless segments. In some embodiments, network 130 may be a secure network. In some embodiments, one or more of the user device 110 and the user device 120 may reside within network 130. In some embodiments, the communication between user devices 110 and 120 and service agent system 140 is a real time communication, such as a chat session or a telephonic session.

The network 130 connects the user devices 110 and 120 to the service agent system 140. In various embodiments, the service agent system 140 may include any number of agent terminals 142 that can participate in real-time communication sessions with user devices 110 and 120. In an embodiment, the service agent system 140 also includes an Intelligent Agent Prompt Producer (IAPP) system 145. In embodiments, the IAPP system 145 may include one or more AI model 148 configured to produce customized user interfaces for each agent terminal for displaying resolution proposals for resolving customer issues. The user interfaces (i.e., how the resolution proposals are displayed) and the subject matter of the resolution proposals may be customized based on both characteristics of the agent terminals 142 (e.g., expertise metrics associated with the agent terminal) and the subject matter of the real-time communication session. In order to generate the user interfaces that include, for example, automatic responses and resolution proposals, the IAPP system 145 may also include an automatic prompt producer that looks at a wide variety of data inputs and generates one or more prompts to the AI model 148. These and other aspects will be discussed in further detail below.

In a first example, the IAPP system 145 is configured to detect characteristics associated with an agent device. One example of a characteristics is the expertise level associated with the agent device. The IAPP system 145 can detect an expertise level of the agent device (e.g., a “new,” “expert”) in comparison to a threshold level (e.g., a number of years at the company, a number of real-time communications that the agent device has participated in). In response to this detection, the IAPP system 145 can generate a prompt that is customized based on the detected expertise level and, in some embodiments, any other contextual data of the real time communication. One example of such as prompt is “Agent is new, summarize like a 5 year old in a simple and detailed manner.” This prompt may be based on detecting the expertise level to be below a predetermined threshold. The IAPP system 145 may then provide the generated prompt as an input to AI model 148 to generate a dynamic user interface that includes the information summarized as indicated by the generated prompt.

Examples of contextual data of the real-time communication include communications received from user devices, such as product inquiries, service inquiries, and technical inquiries. IAPP system 145 can be configured to detect the contextual data, such as an inquiry, identify the inquiry (e.g., using natural language processing (NLP), and generate a query based on the inquiry and the detected expertise level. Other types of contextual data include, but are not limited to, chat transcripts associated with the agent device, chat transcripts associated with the user device, and text data from evaluations or feedback (e.g., from team leaders, from users) associated with the agent device.

Importantly, this sequential process for providing inputs from IAPP system 145 to AI model 148 increases the efficiency of generating more relevant outputs, which is essential in the context of a real-time communication between the agent device and another user device.

In a second example, the IAPP system 145 detects an expertise level above a predetermined expertise threshold (e.g., number of years, number of communications), then the IAPP system 145 can generate a prompt based on that higher expertise level, such as “Agent is an expert, summarize as short and to the point with abbreviations.” The IAPP system 145 may then feed the prompt as input to AI model 148, to generate an appropriate user interface and content based on the expertise level. For example, the content may include a summary and show information associated with contextual data associated with the current real-time communication between the agent device and the user. As one example, the information may relate to efficiency points, which can help to reduce the “Chat Handling Time” and “Customer First Resolution” metrics for the agent, as well as the “Refer to Friend” metric for the user.

In a third example, another example of contextual data detectable by IAPP system 145 is the real-time communication history for that agent device. For example, IAPP system 145 may receive, as input, the real-time communication history over a predetermined time period (e.g., a day) for that agent device, and determine a positive or negative score for the communications. This determination can be based on parsing the text of the communications in the real-time communication history or parsing feedback or evaluations provided by user devices. For example, IAPP system 145 can detect a negative score associated with real-time communications for a predetermined time period, then the IAPP system 145 can generate a prompt based on the detected score and other contextual data (e.g., such as a user query within the current real-time communication). An example of such a prompt may be “Agent has been getting negative chats for 8 out of 10 chats today. Calculate the sentiment accordingly and suggest if the chat should be escalated for a Team Leader review.”

In some embodiments, AI model 148 can be configured to act upon recommendations that it generates. In the example above, the AI model 148 may generate an interface that indicates that the chat should be escalated to a supervisor device, and may automatically perform the recommendation without requiring action from any current devices participating in the real-time communication. AI model 148 may therefore be configured to make adjustments to real-time communication, based on the output that it generates.

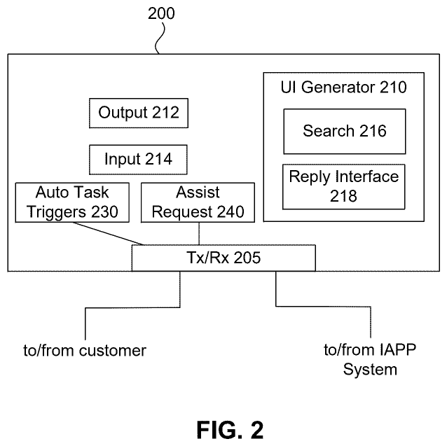

FIG. 2 illustrates an exemplary agent terminal 200 for use in the customer service environment 100 according to aspects of the present disclosure. The agent terminal 200 may represent an exemplary embodiment of agent terminal 142 shown in FIG. 1. As shown in FIG. 2, the agent terminal 200 includes a transceiver 205. Not shown is a communication interface for use with the transceiver 205 that processes incoming and outgoing communications during the real-time communication session. In embodiments, the transceiver 205 sends and received digital messages with the customer over the network 130 as well as with an IAPP system (not depicted). These digital messages are preferably digitally encoded and may adhere to one of a plurality of different communication protocols, including but not limited to TCP/IP, FTP, IP, etc.

The agent terminal 200 may also include output devices 212, input devices 214, and a user interface generator 210. In embodiments, the user interface generator includes all necessary devices and/or functionality to display visual elements that allow the agent to interact with the agent system 140 as well as with the customer during a real-time communication session. These visual elements may include output generated by an AI model that is in communication with the agent terminal 200 during the real-time communication session. As shown in FIG. 2, the agent terminal 200 may include one or more output devices 212 such as a display screen, speakers, etc., an input device 214 such as a keyboard, mouse, microphone, etc. User interface generator 210 may generate visual elements such as a search field by which the agent terminal 200 may receive user input for searching one or more local or online databases, repositories, or systems, and a reply interface by which the agent terminal 200 can transmit responses to customer device. In various embodiments, the reply interface may provide a telephonic channel between the agent terminal 200 the customer device. However, in other embodiments, the reply interface may be customized to allow for input of official (e.g., predefined, AI generated) replies to the customer device via a real-time or messaging chat communication.

In an embodiment, the service agent terminal 200 also includes auto task triggers 230. In embodiments, the auto task triggers 230 monitor the activity of the agent, and detect when AI assistance may be needed. In embodiments, this can include any of a number of different triggers, including but not limited to detecting that the customer has asked a question (in a text message or via a phone call), detecting a subject matter of the customer inquiry, detecting a search query, detecting an elapsed time period in communication during the real-time communication (e.g., a predetermined threshold of silence during a conversation may indicate that the agent is taking too long to respond to the customer), detecting that the real-time communication between the agent terminal 200 and customer device concluded, detecting customer sentiment (e.g., frustration), etc. When any of these triggers has been detected, the auto task triggers 230 may cause the transceiver 205 to transmit a request to the IAPP system for generating automated responses.

In operation, a customer device may initiate a customer call or chat with the agent terminal 200. In various embodiments, the customer call or chat may be assigned to the agent terminal 200 from among a pool of available agent terminals based on one or more parameters associated with the customer device (e.g., a repeat customer, a repeat caller, prior chat history), with the type of the call or chat (e.g., messaging or phone), the subject matter of the call or chat (e.g., a complaint, a question), and the agent terminal 200 (e.g., expertise of the agent associated with the agent terminal 200). User interface generator 210 may provide a chat interface for a voice chat or can be a text chat in the event that the customer communication is provided by the chat interface, such as SMS text messages or an instant messaging service. Communications from the user device will be provided to the customer service agent via output devices 212. The customer service agent may use the input devices 214 and the visual elements from user interface generator 210 to research and identify answers to the customer. The visual elements may be in communication with an AI model and may be updated based on output from the AI model during the real-time communication. Other visual elements, such as a reply bar, may then receive response input into and for transmission to the customer device.

Throughout the real-time communication session between agent terminal 200 and the customer device, auto task triggers 230 continue to monitor the communications transmitted within the communication session (e.g., messages transmitted between agent devices and the customer devices). If, at any time during the real-time communication session, one of the triggers within the communications is detected by the auto task triggers 230, an automatic request for assistance to the IAPP is generated and transmitted thereto by transceiver 205. In embodiments, the agent is also able to manually trigger the AI assistance. This can be done using assist request block 240. In various embodiments, the agent can merely press a single “assist” button, which will cause the IAPP to perform an analysis of the real-time communication session and produce prompts and responses according to any detected conditions with the real-time communication session. Examples of conditions within the session include the subject matter of the communication and the type of the communication. Subject matter of the communication may include whether the communication is a question or a complaint.

For example, regardless of an automatic (e.g., via detection of a trigger) or manual request, the IAPP will analyze communications of the real-time communication session to detect that a communication comprises a question that requires a response from the agent terminal 200. The IAPP will then generate the necessary prompt or prompts for an AI generative model which will then generate AI response to respond to the present circumstances. Other circumstances may result in the IAPP producing different prompts and responses.

In other embodiments, a manual request may include user input via a natural language interface that is provided by user interface generator 210. An example of a natural language query is “how do I unlock a customer account.” In this case, the request is sent to the IAPP system 300 via transceiver 205. The IAPP processes the request, generates the prompt for the AI model, passes the prompt to the AI model, receives an output of the AI model, and returns the resultant answer to the customer service agent via the transceiver 205, as will be discussed in further detail below.

Once the agent terminal 200 has the appropriate response for the customer device 110, the agent terminal 200 enters or otherwise provides the response to the customer device 110. This continues until customer concerns or issues transmitted via the customer device 110 have been resolved or until a connection between the agent terminal 200 and the customer device 110 has terminated. In some embodiments, the agent terminal 200 can perform additional functions aside from direct communication with customer devices 110/120, including summarizing customer conversations, annotating customer conversations, reviewing prior customer conversations, etc.

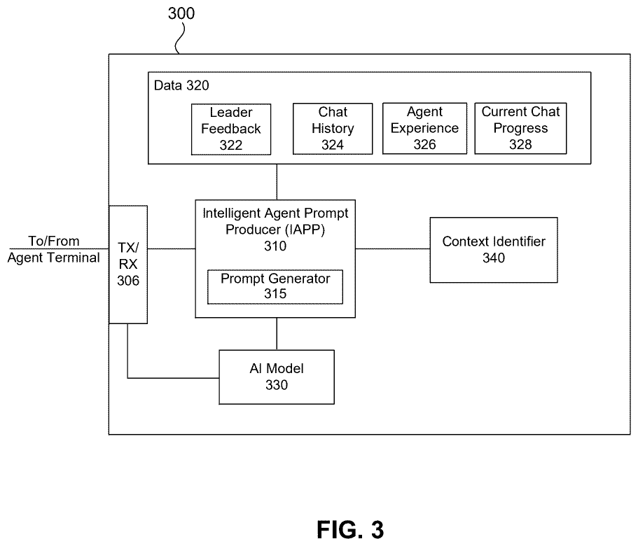

FIG. 3 illustrates an exemplary agent assistance system 300 for use by the agent terminal 200 according to aspects of the disclosure. As shown in FIG. 3, the agent assistance system 300 a transceiver 305 configured to send and receive digital messages with the agent terminal 200. As with the agent terminal, the transceiver 305 may include a communication interface and operate on one or more well-known digital communication interfaces. In embodiments, the transceivers 205 and 305 may be configured for one or more of wireless or wireless communication. The agent assistance system 300 further includes an IAPP 310 having a prompt generator 315. The IAPP 310 is connected to one or more data sources 320. In embodiments, the data sources include, but are not limited to, agent data including leader feedback 322, and agent experience 326, as well as other data including chat history 324 and current chat progress 328, among others. The IAPP 310 is also connected to an AI model 330. In embodiments, the AI model 330 is a generative AI, as will be described in detail below.

In embodiments, the agent assistance system 300 can be integrated into one or more of the agent terminals 200, or can be local to the service agent system 140, in some cases sharing a data bus or local area network with the agent terminals. In other embodiments, the agent assistance system 300 is located remote from the service agent system.

A number of different scenarios can trigger the IAPP 310 to generate a prompt for the AI model 330. For example, the agent assistance system 300 may receive an explicit request from the agent via the transceiver 305, or a triggered request generated by the agent terminal 200 via the transceiver. In some embodiments, the agent assistance system 300 may receive chat data associated with a current chat of the agent. The agent assistance system 300 may perform its own automatic trigger detection operation in order to determine whether the agent will benefit from assistance. In an embodiment, this can be performed by a context identifier 340, which analyzes the data of the current chat and determines whether AI assistance is needed. In embodiments, this can be based on one or more rules or metrics.

Regardless of what triggers the prompting, the IAPP will then generate a prompt for the AI model 330. In order to achieve this, the IAPP may retrieve a wide variety of data from the data sources 320. For example, as shown in FIG. 3, data may include leader feedback 322. In an embodiment, the leader feedback 322 may include an administrator's review feedback as it relates to the agent, and may include strengths or weaknesses of the agent and/or past successes or failures to appropriately handle certain customer issues. This information can be used by the IAPP 310 to assess the agent's skill level with regard to a particular issue or generally, so as to modify the prompt to adjust for the agent's abilities. This can present itself, for example, as a level of granularity or clarity of the AI's response instructions.

In embodiments, the data sources 320 also includes chat history 324. In embodiments, the chat history 324 may include a transcript or recording of the current chat with the current customer. In other embodiments, chat history 324 may include past chats between the agent and past customers. The IAPP 310 can use this information to identify which actions have already been taken in the present chat, which issues the agent has experience with, and customer sentiment, among others.

In embodiments, the data sources 320 also includes agent experience. This can include a relative skill level of the agent, or can be granulated to different issues. In other words, the agent experience 326 may indicate whether the agent is a novice or veteran agent generally, or can indicate whether the agent is a novice or veteran with respect to specific issues or topics.

In embodiments, the data sources 320 also includes current chat progress 328. The current chat progress can include a listing of issues raised, actions taken in response to those issues, agents that the customer has spoken to during the current chat session, escalations to one or more supervisors, etc.

Once the IAPP 310 has obtained the relevant data, the IAPP generates a prompt for the AI model 330 using its prompt generator 315. A prompt is the interaction between the general system and the AI model 330 that enables the AI model 330 to generate a desired result. The prompt may conform to a format and/or syntax associated with the AI model. In an embodiment, the AI model is a generative AI model—e.g., a deep-learning model that can generate high-quality text, images, and other content based on its training. In an embodiment, the prompt may require certain header information or footer information, and may have a number of required or optional fields. The prompt generator 315 produces the AI prompt to meet the requirements of the specific prompt format associated with the AI, and tailored to the unique circumstances of the agent and/or current customer situation based on the retrieved data. In embodiments, this is a rules-based algorithm, whereas in other embodiments the prompt generator 315 itself includes AI or other machine-learning model configured to analyze the retrieved data and generate the prompt according to the specific format of the AI model 330 as well as to satisfy the agent's needs and abilities.

In a first example, the context identifier 340 determines that an agent's call with a customer just concluded. This triggers the IAPP 310 to request a call summary from the AI model 330. Thus, the IAPP retrieves information from data sources 320 relating to at least agent experience 326 and chat progress 328. The prompt generator 315 then generates the AI prompt based on the retrieved data. For an agent with less experience, the prompt generator 315 may prepare a prompt that requests a deeper level of granularity for the summary, whereas the prompt may request a higher-level summary for an agent with more experience. Once the prompt has been generated, it is provided to the AI model 330 in order to trigger the AI model 330 to generate the requested response. The AI model generates the summary, which is then provided to the agent via the transceiver 305.

In another example, the agent assistance system 300 receives a request from the agent for assistance without any context. Context identifier 340 reviews the current state of the conversation between the agent and the customer and determines that the agent recently asked a question that has gone unanswered. The context identifier 340 notifies the IAPP 310 to answer the question. This causes the IAPP 310 to retrieve information from data sources 320, such as leader feedback 322, chat history 324, agent experience 326, and current chat progress 328. The prompt generator 315 then generates a prompt for the AI model 330 to answer the question in a manner that can be readily understood and explained/handled by the agent. In embodiments, the resulting reply is tailored the agent's abilities and/or experience levels and explains to the agent how to respond and/or resolve the customer's question. This reply is then forwarded to the agent via the transceiver 305.

In the manner described above, an agent can be quickly provided with accurate and understandable response instructions for resolving customer issues and other actions. This can not only result in higher agent satisfaction, but can also significantly improve customer sentiment, which has numerous benefits to the company including customer retention and referral.

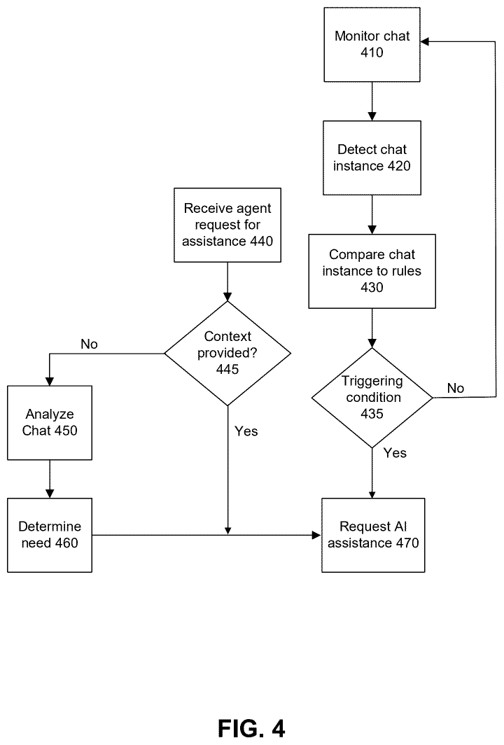

FIG. 4 illustrates an exemplary method 400 for initiating an AI assistance request according to aspects of the present disclosure. As shown in FIG. 4, the method 400 begins in step 410 by IAPP system 145 monitors a chat between a user device and an agent device during a real-time communication. In embodiments, this may involve monitoring a series of voice communications or text communications exchanged between the user device and the agent device during a real-time communication. The IAPP system 145 may be configured with multimodal components for monitoring different types of communications including a speech recognition and speaker recognition component, a natural language processing (NLP) component, and an image recognition component, and an optical character recognition (OCR) component.

The IAPP system 145 with the speech recognition and speaker recognition component may be configured to detect speech during a voice conversation to identify relevant contexts that may be used to trigger the prompting process between IAPP system 145 and AI model 148 for generating relevant user interfaces in aid in the real-time communication. With the natural language processing (NLP) component, the IAPP system 145 may be configured to monitor text-based communications to identify relevant keywords for triggering the prompting process between IAPP system 145 and AI model 148. Similarly, with the image recognition component, IAPP system 145 may be configured to scan images (e.g., screenshots provided by user device) to identify information in the image. And with the OCR component, IAPP system 145 may further be configured to identify text within the images and use the identified text, in context with other information within the real-time communication to monitor the real-time communication.

In step 420, based on the monitoring discussed above, IAPP system 145 can identify instance of interest (or triggers) in the real-time communication. Such instances may include a threshold amount content exchanged during the real-time communication, or can be based on specific words, phrases, or occurrences detected in voice, text, or image data provided in the real-time communication. For example, the IAPP system 145 may detect the word “help”, the phrase “let me look into that for you,” or the occurrence of any question and can initiate the prompt process between IAPP system 145 and AI model 148. As another example, IAPP system 145 may be trained to identify a tone (e.g., a negative score, a positive score) of the real-time communication, such as by IAPP detecting specific phrases or combination of phrases within communications that are exchanged during the real-time communication.

In step 430, the IAPP system 145 can compare one or more detected instances or other information from the real-time communication to trigger rules. In an embodiment, the instance causes IAPP system 145 to review of recent communications in the chat to determine whether any rules have been triggered. Alternatively, the occurrence of a particular instance may cause IAPP system 145 to initiate a specific review relating to the detected instance. The rules can include any number of predefined triggering conditions, such as whether a particular topic was raised, whether a question was asked, whether more than a predetermined amount of time has passed since some starting condition (e.g., a question or the start of the call), among others.

In some embodiments, the predefined triggering conditions may be adapted based on characteristics of the agent device. For example, an agent device with positive scores on communications and/or a particular expertise level may be associated with different triggering conditions than another agent device with negative scores on communications and/or a lower expertise level. The IAPP system 145 can be configured to adjust the predefined triggering conditions over time.

In step 435, the IAPP system 145 can determine whether any of the rules have been satisfied—i.e., whether a triggering condition has occurred. If no such condition has occurred, then the method 400 returns to step 410 for further monitoring of the real-time communication. Alternatively, if a triggering condition has been detected, then the method 400 proceeds to step 470, where the IAPP system can initiate the prompting procedure with AI model 148.

At any time during monitoring real-time communications (i.e., step 410), the IAPP system 145 can receive a manual request from one or more devices (e.g., agent terminals 142 or user devices 110 and 120) for initiating the prompting procedure during the real-time communication, at step 440. In various embodiments, one or more devices, such as agent terminals 142 or user devices 110 and 120 may activate a visual button on a graphical user interface displayed on agent terminals 142 or user devices 110 and 120. In other embodiments, agent terminal 142 may provide a spoken or typed request that is received by IAPP system 145 during the real-time communication. As part of the manual request, activation of the visual button may cause the agent terminal 142 to provide certain context or directives, which the system will use to quickly identify the nature of the request. Examples may include the agent device typing a question or a request, such as “how do I unlock a locked account?” or “where can I find the user's login information?” etc.

Therefore, in step 445, IAPP system 145 can determine whether contextual information was provided with the manual request. If such information was provided (445—Yes), then the method 400 proceeds directly to step 470, where AI assistance is immediately requested by transmitting a request to the IAPP. Alternatively, no such contextual information was provided (445—No), then IAPP system 145 performs additional steps to identify the nature of the request.

For example, in step 450, IAPP system 145 analyzes the real-time communication, which may include any combination of text data (e.g., a chat), audio data (e.g., a voice call), or image data. In embodiments, this analysis can include several of the same analyses as described with respect to step 420, including speaker identification, speech recognition, text and image recognition, topic identification, and current posture of the real-time communication. Once analyzed, IAPP system 145 identifies the any relevant trigger conditions within the real-time communication, such as the agent's need, such as assistance with answering a question, resolving a problem, or merely summarizing a terminated conversation, in step 460. This is used as the basis for requesting AI assistance in step 470, where the method ends.

It will be understood that the order of the above steps are merely exemplary, and the steps can be rearranged in any appropriate manner, and that the method can be modified consistent with the present disclosure. Additionally, more or fewer steps may be included in the exemplary method consistent with the disclosure. For example, in embodiments, the method 400 may bypass steps 450 and 460, instead immediately requesting AI assistance in step 470. The AI model 330 or the IAPP 310 is then tasked with identifying the context of the assistance, such as through the generation of the prompt performed by the IAPP 310 or the resulting analysis performed by the AI model 330.

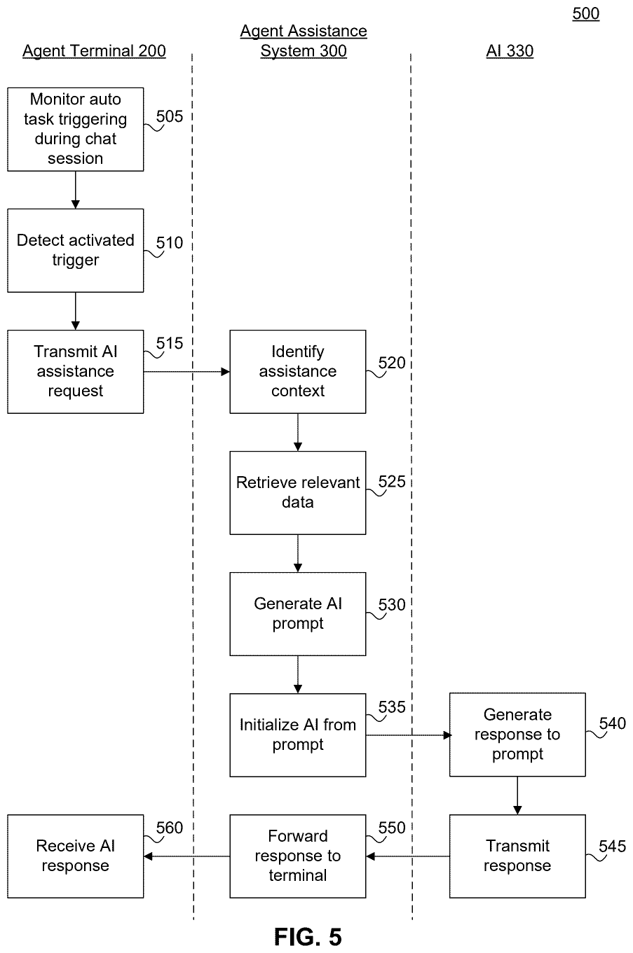

FIG. 5 illustrates a flowchart diagram of an exemplary method 500 for providing AI assistance by generating user interfaces and associated content to an agent device. As shown in FIG. 5, the method 500 occurs between the agent terminal 200, the agent assistance system 300, and the AI 330. The method 500 begins with step 505 in which the agent terminal monitors auto task triggers during an agent session. As discussed above, there may be a wide variety of auto task triggers that can trigger AI assistance, including but not limited to detecting that the customer has asked a question (in a text message or via a phone call), detecting a subject matter of the customer inquiry, detecting a search query, detecting an elapsed time period in communication during the real-time communication (e.g., a predetermined threshold of silence during a conversation may indicate that the agent is taking too long to respond to the customer), detecting that the real-time communication between the agent terminal 200 and customer device concluded, detecting customer sentiment (e.g., frustration), etc.

In step 510, the agent terminal 200 detects that one of the auto task triggers has been activated. In response, the agent terminal 200 transmits a request for AI assistance to the agent assistance system 300 in step 515. For purposes of this explanation, it is presumed that no context information is provided in the request. However, in other embodiments, the agent terminal 200 may gather and transmit context information along with the request to aid the agent assistance system 300 in generating an appropriate AI prompt, as discussed above.

In step 520, the agent assistance system 300 detects the assistance context, such as agent expertise level, communications received from the user device, a customer inquiry, etc. In embodiments, this step seeks to identify the specific assistance that is required—e.g., a call summary, an answer to a question, a resolution to a problem, etc.

In step 525, the agent assistance system 300 retrieves relevant data relating to the identified context from one or more data sources. In embodiments, these data sources may be local or on a nearby network, whereas in other embodiments, external and/or remote data sources may be used, including but not limited to third-party databases and the Internet. Such information may include leader feedback, chat history, agent expertise, and current chat progress, among others.

In step 530, the agent assistance system 300 automatically generates an AI prompt using the retrieved data and the assistance context. In embodiments, the prompt conforms to a format and syntax required by the AI, and may include information relevant to tailor the AI's response to the specifics of the present circumstances and agent abilities/expertise. In various embodiments, the prompt may be generated by one or more rules algorithms and/or by a machine-learning model trained with prompt use cases. In embodiments, additional data may be output along with the generated prompt that can be used by the AI model in order to generate a responsive output. This may include, for example, any context information identified by the agent assistance system 300 in earlier steps and/or additional content, such as chat data, user history, etc.

In step 535, the agent assistance system 300 initializes the AI model 330 using the generated prompt and, in some embodiments, the additional context information and/or content data.

In step 540, the AI model 330 receives the prompt from the agent assistance system 300 and generates the appropriate response to the prompt. In other words, the AI model 330 performs an analysis relevant to the context of the real-time communication, agent's current circumstances and skill level, and produces an output responsive thereto. The AI model 330 then transmits the generated response back to the agent assistance system 300 in step 545. In step 550, the agent assistance system 300 receives the response from the AI model 330 and forwards it to the agent terminal 200. The agent terminal 200 receives the AI response in step 560, where the method ends. In various embodiments, the response is provided directly in the agent's chat window with the user, or can be provided in a separate “help” window.

It will be understood that the order of the above steps are merely exemplary, and the steps can be rearranged in any appropriate manner, and that the method can be modified consistent with the present disclosure. Additionally, more or fewer steps may be included in the exemplary method consistent with the disclosure.

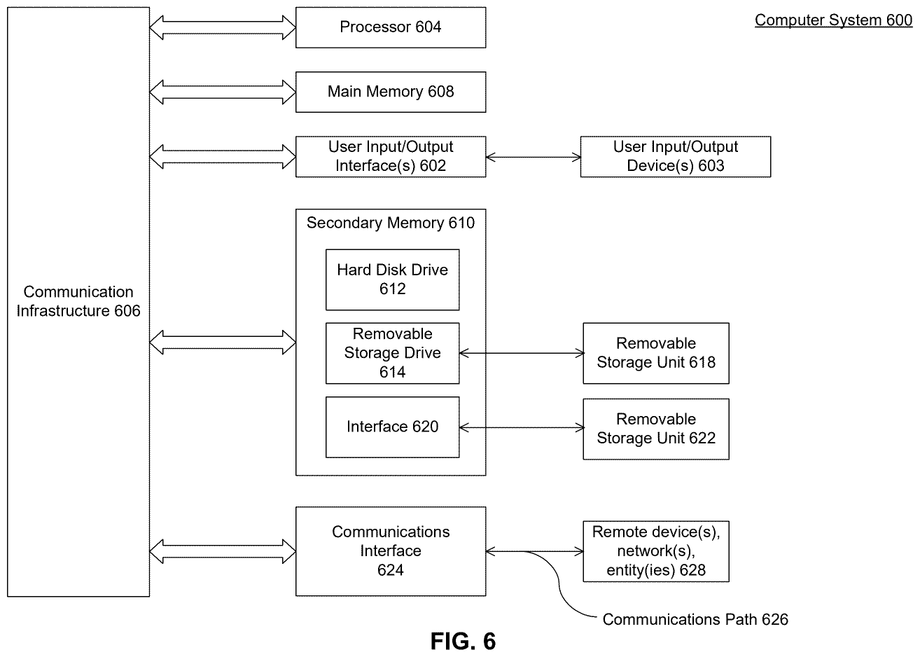

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof, including but not limited to the agent terminal 200, the agent assistance system 300, the IAPP 310, the prompt generator 315, and/or the AI 330.

Computer system 600 may include one or more processors (also called central processing units, or CPUs), such as a processor 604. Processor 604 may be connected to a communication infrastructure or bus 606.

Computer system 600 may also include customer input/output device(s) 603, such as monitors, keyboards, pointing devices, etc., which may communicate with communication infrastructure 606 through customer input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random-access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings included in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. An agent assistance system, comprising:
a memory that stores agent data associated with an agent terminal; and
one or more processors configured to:
detect a trigger in a real-time communication between the agent terminal and a customer device;
generate, by a first AI (artificial intelligence) model and responsive to detecting the trigger, contextual data relating to content in the real-time communication, the contextual data including a real-time communication;
retrieve, by the first AI model and responsive to the generating of the contextual data, the agent data from the memory, the agent data including an experience level of the agent;
generate, by the first AI model, an AI prompt based on the contextual data and the agent data;
provide the AI prompt to an assistance model of a second AI model, wherein the assistance model is configured to generate a visual element comprising a customized component responsive to the prompt, wherein the customized component includes textual data for display on the agent terminal;
receive the visual element comprising the customized component from the assistance model; and
modify a user interface provided to the agent so as to include the visual element.

2. The agent assistance system of claim 1, wherein the trigger includes a detected question received from the customer device during the real-time communication.

3. The agent assistance system of claim 1, wherein the one or more processors are further configured to monitor an elapsed time of a real-time communication session associated with the customer device, wherein the trigger includes the elapsed time exceeding a predetermined threshold.

4. The agent assistance system of claim 1, wherein the one or more processors are further configured to:
monitor communication during a real-time communication session; and
generate, based on the monitored communication, a score for customer sentiment during the real-time communication session, wherein the trigger comprises determining that the generated score is a negative score.

5. The agent assistance system of claim 1, wherein a need for AI assistance is detected based on an analysis of a real-time communication session between the customer device and the agent terminal during the real-time communication.

6. The agent assistance system of claim 5, wherein the analysis includes:
comparing content of the real-time communication to a plurality of triggering conditions; and
determining whether one of the plurality of triggering conditions has been satisfied.

7. The agent assistance system of claim 1, wherein a need for AI assistance is detected based on receiving an express request from an agent device, the request including context information relating to the need for agent assistance during the real-time communication session.

8. The agent assistance system of claim 1, wherein the one or more processors are further configured to:
receive a response from the first AI model tailored to at least one of a skill level or expertise of an agent associated with the agent terminal.

9. A method, comprising:
detecting a trigger in a real-time communication between an agent terminal and a customer device;
generating, by a first AI (artificial intelligence) model and responsive to detecting the trigger, contextual data relating to content in the real-time communication, the contextual data including a real-time communication;
retrieving, by the first AI model and responsive to generating the contextual data, agent data from a database, the agent data including an experience level of the agent;
generating, by the first AI model, an AI prompt to an assistance model of a second AI model based on the contextual data and the agent data, wherein the assistance model is configured to generate a visual element comprising a customized component responsive to the AI prompt, wherein the customized component includes textual data for display on the agent terminal;
receiving the visual element comprising the customized component from the AI model; and
modify a user interface provided to the agent so as to include the visual element.

10. The method of claim 9, wherein the agent data includes information relating to an expertise or skill level of an agent, and
wherein the visual element is tailored to at least one of the skill level or the expertise of the agent.

11. The method of claim 9, wherein the trigger includes a detected question received from the customer device during the real-time communication.

12. The method of claim 9, further comprising monitoring and analyzing a customer sentiment during a real-time communication session, wherein the trigger includes detecting a negative customer sentiment.

13. The method of claim 12, wherein a need for AI assistance is detected based on an analysis of the real-time communication, the analysis including:
comparing content of the real-time communication to a plurality of triggering conditions; and
determining whether one of the plurality of triggering conditions has been satisfied.

14. The method of claim 9, wherein a need for AI assistance is detected based on receiving an express request from an agent device, the request including context information relating to the need for agent assistance during the real-time communication session.

15. A non-tangible computer readable storage medium comprising instructions that, when executed by one or more processors of a computer, cause the one or more processors to:
detect a trigger in a real-time communication between an agent terminal and a customer device;
generate, by a first AI (artificial intelligence) model and responsive to detecting the trigger, contextual data relating to content in the real-time communication, the contextual data including real-time communication;
retrieve, by the first AI model and responsive to generating the contextual data, agent data from a database, the agent data including an experience level of the agent;
generate, by the first AI model, an AI prompt based on the contextual data and the agent data;
provide the AI prompt to an assistance model of a second AI model, wherein the assistance model is configured to generate a visual element comprising a customized component responsive to the prompt, wherein the customized component includes textual data for display on the agent terminal;
receive the visual element comprising the customized component from the assistance model of the second AI model; and
modify a user interface provided to the agent so as to include the visual element.

16. The non-tangible computer readable storage medium of claim 15, wherein the agent data includes information relating to an expertise or skill level of an agent, and
wherein the received visual element is tailored to at least one of the skill level or the expertise of the agent.

17. The non-tangible computer readable storage medium of claim 15, wherein the trigger includes a detected question received from the customer device during the real-time communication.

18. The non-tangible computer readable storage medium of claim 15, wherein the instructions further cause the one or more processors to monitor and analyze a customer sentiment during a real-time communication session, wherein the trigger includes detecting a negative customer sentiment.

19. The non-tangible computer readable storage medium of claim 18, wherein the instructions further cause the one or more processors to detect a need for AI assistance based on analysis of the real-time communication, the analysis including:
comparing content of the real-time communication to a plurality of triggering conditions; and
determining whether one of the plurality of triggering conditions has been satisfied.

20. The non-tangible computer readable storage medium of claim 15, wherein a need for AI assistance is detected based on an express request from an agent device, the request including context information relating to the need for agent assistance during the real-time communication session.
